(19) United States
(12) Patent Application Publication
(10) Pub. No.: US 2022/0311091 A1
(43) Pub. Date: Sep. 29, 2022

(54) COATED SEPARATOR WITH FLUOROPOLYMERS FOR LITHIUM ION BATTERY

(71) Applicant: Arkema Inc., King of Prussia, PA (US)

(72) Inventors: Yujie LIU, King of Prussia, PA (US); Yuanqin LIU, King of Prussia, PA (US)

(21) Appl. No.: 17/618,915

(22) PCT Filed: Jun. 23, 2020
(86) PCT No.: PCT/US20/39100

§ 371 Date: Dec. 14, 2021

Related U.S. Application Data
(60) Provisional application No. 62/866,314, filed on Jun. 25, 2019.

(51) Int. Cl. H01M 50/426; H01M 50/449; H01M 50/403

(52) U.S. Cl. CPC H01M 50/426; H01M 50/449; H01M 50/403

(57) ABSTRACT

The invention relates to a fluoropolymer-acrylic coating composition that can be used, for example, in coating electrodes and/or separators in electrochemical devices. A coated separator for a lithium ion battery contains the porous separator substrate, and coatings on at least one side of the separator. The coating consists of an inorganic coating on at least one side of the separator, and an adhesive organic coating on at least one side of the inorganic coating or the separator. The organic coating contains an improved fluoropolymer-acrylic composition or a mixture of fluoropolymer and acrylic. The present invention can improve the adhesion of the coated separator to electrodes.

This application claims priority to U.S. provisional application 62/866,314 filed Jun. 25, 2019 and is herein incorporated by reference.

### FIELD OF THE INVENTION

The invention relates to the fluoropolymer binder composition used in coating separators in electrochemical devices.

### BACKGROUND OF THE INVENTION

US2014/0322587, US 2015/0280197, US 2017/0288192 and US 2018/0233727 all mentioned acrylic type resin as a candidate in the physical blending system of the separator coating. US 2015/0280197, US 2017/0288192 and US 2018/0233727 mixed the acrylic type resin with PVDF-HFP or PVDF type resin to provide adhesion of the separator coating to the separator. US 2015/0280197 emphasizes the coating thickness to be 1 to 8 micron meter. US 2017/0288192 emphasizes the coating density of the PVDF related coating and the particle size of the organic polymer to be in the range of 1 to 150 micron meter. US 2018/0233727 emphasizes that the acrylic type resin was synthesized by adding acrylic type monomer and styrene type monomer. Then mix the acrylic type resin with different ratio to PVDF-HFP copolymer. US2014/0322587 emphasizes the melting point and particle size of the polymer wax.

Currently available lithium ion batteries and lithium ion polymer batteries use polyolefin-based separators in order to prevent a short circuit between a cathode and an anode. However, because such polyolefin-based separators have a melting point of 140° C. or less, they can shrink melt in use, resulting in a change in volume when the temperature of a battery is increased by internal and/or external factors, and that may cause a short-circuit. Additionally, polyolefin-based separators are susceptible to oxidation when in contact with high voltage active materials. Oxidation of polyolefin separators reduces the cycle life and generates pin-holes, and that may cause a short-circuit. The short circuit can result in accidents—such as explosion or fire in a battery caused by emission of electric energy. As a result, it is necessary to provide a separator that does not cause heat shrinking at high temperature or oxidize at high voltage.

Polyvinylidene fluoride, because of its excellent electro-chemical resistance and superb adhesion among fluoropolymers, has been found to be useful as a binder or coating for the separator of a non-aqueous electrolytic devices. U.S. Pat. Nos. 7,662,517, 7,704,641, US 2010/00330268, U.S. Pat. No. 9,548,167, and US 2015/0030906 incorporated herein by reference, describe a PVDF copolymer solution in organic solvents and in aqueous dispersion which is used in conjunction with a powdery metal oxide materials or nano-ceramics in the coating of a polyolefin separator to be used in a non-aqueous-type battery. The separator forms a barrier between the anode and the cathode in the battery. It was found that the bound inorganic particles on the porous organic separator increased the volume of space that a liquid electrolyte infiltrates, resulting in improved ionic conductivity.

Unfortunately, the excellent properties provided by fluoropolymers can also limit the applications in which they can be used. For example, it is difficult to adhere fluoropolymers to other materials. Therefore, organic solvent and other organic additives are generally used in a coating formulation to provide good adhesion (non-reversible adhesion) between PVDF-based polymers and a porous separator and optionally added powdery particles.

A fluoropolymer-based composition used in the separator of an electrochemical device should have excellent dry adhesion. Mechanical strength can be obtained by using a fluoropolymer having high crystallinity. Unfortunately, these high crystalline fluoropolymers have poor dry adhesion. Functional polymers provide good dry adhesion, but have reduced crystallinity, and thus compromise the binder's mechanical strength.

Surprisingly, it has now been found that a crosslinkable acrylic fluoropolymer resin composition can provide both good dry adhesion and good swellability characteristics when used as a binder on a battery separator. The crosslinkable acrylic fluoropolymer resin is used as the polymer binder. Separators coated with the polymer binder resin not only have good mechanical strength and good dry adhesion, but also provide the separator with dimensional stability at elevated temperature, in that they have good swelling characteristics.

Current products do not have the balance of both dry adhesion and swelling, as found in the fluoropolymer binder composition of the invention.

### The Invention

The object of the invention is to provide a material with an improved adhesive property for a separator coating when used in a lithium ion battery application. The material is used as the polymer binder or adhesion component on the separator. Current published patents use physical blends of fluoropolymer and acrylic polymer as adhesive component. These blends were prepared by producing each polymer separately and then physical blending/mixing the two individual polymers together. This invention provides a new chemistry solution for a separator coating. Instead of the physical mixture of fluoropolymer and acrylic, the improved fluoropolymer-acrylic composition is synthesized by emulsion polymerization of acrylate/methacrylate monomers using fluoropolymer latex as seed. The acrylic portion of the acrylic modified fluoropolymer is capable of cross-linking. It can be self-crosslinking or can crosslink using a crosslinking agent.

The adhesion to the electrode of the separator coated with the material in this invention is at least 2 times as compared to the blend polymers having similar ratio of chemical components. The material of this invention provides for at least 2 times the adhesion compared to the blend/mixture of polymers of similar composition and preferably at least 3 times the adhesion. The adhesion of the binder is at least 10 N/m. Preferably, the adhesion is from 10 N/m to 200 N/m or more, more preferably from 10 N/m to 175 N/m, preferably 15 N/m to 175 N/m.

The fluoropolymer-acrylic composition is synthesized by emulsion polymerization of (meth)acrylate monomers using fluoropolymer latex as seed. The process is analogous to that described in U.S. Pat. Nos. 5,349,003, 6,680,357 and US 2011/0118403. The polymer binder used in the present invention is formed in a process wherein a fluoropolymer is employed as seed in a polymerization of acrylic polymers from acrylic monomers and monomers copolymerizable with acrylic monomers to form what will be referred to herein as “AMF polymers”. In the present invention, the AMF polymers have, in the acrylic portion, functional groups capable of reacting with other functional groups in the acrylic portions of other AMF polymers either with or without the aid of separate crosslinking aids to form crosslinked AMF polymers.

The invention relates to a binder composition containing a crosslinkable fluoropolymer-acrylic composition synthesized by emulsion polymerization of acrylate/methacrylate monomers using fluoropolymer latex as seed.

The invention further relates to a formulation comprising a cross linkable fluoropolymer-acrylic composition in a solvent, and may further comprise electrochemically stable powdery particulate materials and may optionally further contain other additives.

The invention further relates to a separator coated with the cross linkable fluoropolymer-acrylic composition. These coated separators find uses in applications such as for a separator for a battery or capacitor.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

All references listed in this application are incorporated herein by reference. All percentages in a composition are weight percent, unless otherwise indicated.

Unless otherwise stated, molecular weight is a weight average molecular weight as measured by GPC, using a polymethyl methacrylate standard. In cases where the polymer contains some cross-linking, and GPC cannot be applied due to an insoluble polymer fraction, soluble fraction/gel fraction or soluble faction molecular weight after extraction from gel is used. Crystallinity and melting temperature are measure by DSC as described in ASTM D3418 at heating rate of 10 C/min. Melt viscosity is measured in accordance with ASTM D3835 at 230° C. expressed in k Poise @100 Sec\hat{ }(−1).

The term “polymer” is used to mean both homopolymers, copolymers and terpolymers (three or more monomer units), unless otherwise stated. Copolymer” is used to mean a polymer having two or more different monomer units. For example, as used herein, “PVDF” and “polyvinylidene fluoride” is used to connote both the homopolymer and copolymers, unless specifically noted otherwise. The polymers may be homogeneous, heterogeneous, and may have a gradient distribution of co-monomer units.

The term “binder” is used to refer to the crosslinkable fluoropolymer acrylic composition or a fluoropolymer acrylic composition that contains functionality that can cross link, that can be coated onto a substrate, preferably contains particles for improved dimensional stability, and for this invention a substrate is primarily a separator as found in an electrochemical device (for example a lithium ion battery).

Crosslinkable means that the acrylic portion of the fluoropolymer acrylic resin has functionality in the monomers that can crosslink or contains a crosslinking agent.

Acrylic encompasses both acrylic and meth acrylic monomers unless otherwise specified.

Dry adhesion: To develop dry adhesion, the crosslinkable fluoropolymer acrylic resin must during a casting and/or the compression step adhere to the electrode or separator, and adhere to any inorganic particles in the coating. In a solution based casting, the polymer is dissolved in a solvent and coats the substrate and the inorganic particles. In water based or latex casting, the polymer particles must deform enough to adhere to the electrode or separator. Generally, the higher adhesion the better. Adding functionality to the polymer could enhance the adhesion. Wet adhesion relates to the fluoropolymer swollen in electrolyte. The electrolyte tends to soften the fluoropolymer in a manner similar to that caused by a plasticizer. Adding functionality to the fluoropolymer tends to soften the fluoropolymer making it less brittle and increase swelling. Therefore, a very soft binder able to generate good dry adhesion may be too soft when swollen by electrolyte, will lose its cohesion strength, and will not develop a good wet adhesion.

Fluoropolymers, particularly poly(vinylidene fluoride) (PVDF) and its copolymers, find application as the binder in electrode articles used in lithium ion batteries. As the demand for greater energy density and battery performance intensifies, the need for reduction of the binder content in the electrodes has increased. To reduce the binder content, it is paramount to increase the performance of the binder material. One key binder performance matrix is determined by an adhesion test whereby a formulated electrode is subjected to a peel test. Improved binding performance increases the potential to reduce the overall binder loading, increasing active material loading and improving battery capacity and energy density.

The binder used in the present invention is a curable composition (crosslinkable) comprising an acrylic modified fluoropolymer preferably based on a polyvinylidene fluoride polymer selected from the group polyvinylidene fluoride homopolymer and polyvinylidene fluoride-hexafluoropropylene copolymer wherein the acrylic phase contains monomer residues having functional groups whereby the acrylic phase can become crosslinked, entering into a crosslinking reaction.

The present invention provides for the use of a crosslinking able fluoropolymer acrylic AMF polymer as a binder in battery separators having improved binding performance. The fluoropolymer-acrylic composition provides enhanced properties compared to the fluoropolymer, such as increased adhesion. The invention may provide increased hydrophilic characteristics. The fluoropolymer of the invention may be used in applications benefiting from a functional fluoropolymer including as binders in electrode-forming compositions and separator compositions.

A coated separator for a lithium ion battery contains a porous separator substrate, and coating on at least one side of the separator. Preferably, the coating has an inorganic material portion and an adhesive polymer portion. The inorganic and the adhesive polymer can be blended and applied to the separator as a single coating or the inorganic material and the adhesive polymer can be applied as separate layers. Coating can be applied to one side or both sides of the separator. The adhesive polymer contains an improved fluoropolymer-acrylic composition which crosslinks. The AMF is crosslinked in the dry coating on the separator. The present invention improves the adhesion of the coated separator to electrodes.

The invention further relates to a formulation comprising the crosslinkable fluoropolymer-acrylic composition in a solvent. The solvent is preferably chosen from: water, n-methylpyrrolidone (NMP), dimethylsulfoxide (DMSO), N,N-dimethylformamide (DMF), triethylphosphite (TEP), acetone, cyclopentanone, tetrahydrofuran, methyl ethylketone (MEK), methyl isobutyl ketone (MiBK), ethyl acetate (EA), butyl acetate (BA), ethylene carbonate (EC), propylene carbonate (PC), dimethyl carbonate (DMC), diethyl carbonate (DEC) or ethyl methyl carbonate (EMC).

According to this invention, there is provided an aqueous fluorine-containing polymer dispersion having particle diameters of 0.05-3 μm, obtained by emulsion-polymerizing 5 to 100, preferably 5-95 parts by weight of a monomer mixture having at least one monomer selected from the group consisting of alkyl acrylates whose alkyl groups have 1-18 carbon atoms and alkyl methacrylates whose alkyl groups have 1-18 carbon atoms and optionally an ethylenically unsaturated compound copolymerizable with the alkyl acrylates and the alkyl methacrylates, in an aqueous medium in the presence of 100 parts by weight of particles of a vinylidene fluoride polymer.

The swelling ratio is preferably from 175 wt % to 1000 wt %, more preferably from 175 wt % to 900 wt %.

### Seed Fluoropolymers

The fluoropolymers used in the invention as seed for the acrylic polymerization are formed primarily of fluoromonomers. The term “fluoromonomer” or the expression “fluorinated monomer” means a polymerizable alkene which contains at least one fluorine atom, fluoroalkyl group, or fluoroalkoxy group attached to the double bond of the alkene that undergoes polymerization. The term “fluoropolymer” means a polymer formed by the polymerization of at least one fluoromonomer, and it is inclusive of homopolymers, copolymers, terpolymers and higher polymers which are thermoplastic in their nature, meaning they are capable of being formed into useful pieces by flowing upon the application of heat, such as is done in molding and extrusion processes. The fluoropolymer preferably contains at least 50 mole percent of one or more fluoromonomers.

Fluoromonomers useful in the practice of the invention include, for example, vinylidenefluoride (VDF), tetrafluoroethylene (TFE), trifluoroethylene (VF3), chlorotrifluoroethylene (CTFE), hexafluoropropene (HFP), vinyl fluoride (VF), hexafluoroisobutylene, perfluorobutylethylene (PFBE), pentafluoropropene, 2,3,3,3-tetrafluoropropene (HFO-1234yf), 2-chloro-1-1-difluoroethylene (R-1122), 3,3,3-trifluoro-1-propene, 2-fluoromethyl-3,3,3-trifluoropropene, a fluorinated vinyl ether, a fluorinated allyl ether, a non-fluorinated allyl ether, a fluorinated dioxole, and combinations thereof.

The fluoropolymer used as seed particles is preferably a vinylidene fluoride polymer obtained by emulsion-polymerization. Such an aqueous vinylidene fluoride polymer dispersion can be produced by a conventional emulsion polymerization method, for example, by emulsion polymerizing the starting monomers in an aqueous medium in the presence of a polymerization initiator, this process is known in the art. Specific examples of the vinylidene fluoride polymer obtained by emulsion-polymerization include vinylidene fluoride homopolymer and copolymers of (1) vinylidene fluoride and (2) a fluorine-containing ethylenically unsaturated compound (e.g. tetrafluoroethylene (TFE), trifluoroethylene (VF3), chlorotrifluoroethylene (CTFE), hexafluoropropene (HFP), vinyl fluoride (VF), hexafluoroisobutylene, perfluorobutylethylene (PFBE), pentafluoropropene, 2,3,3,3-tetrafluoropropene (HFO-1234yf), 2-chloro-1-1-difluoroethylene (R-1122), 3,3,3-trifluoro-1-propene, 2-fluoromethyl-3,3,3-trifluoropropene, a fluorinated vinyl ether, a fluorinated allyl ether, a non-fluorinated allyl ether, a fluorinated dioxole, perfluoroacrylic acid or the like), a fluorine-free ethylenically unsaturated compounds (e.g. cyclohexyl vinyl ether, hydroxyethyl vinyl ether or the like), a fluorine-free diene compound (e.g. butadiene, isoprene, chloroprene or the like) or the like, all of them being copolymerizable with vinylidene fluoride. Of these, preferred are vinylidene fluoride homopolymer, vinylidene fluoride/tetrafluoroethylene copolymer, vinylidene fluoride/hexafluoropropylene copolymer, vinylidene fluoride/tetrafluoroethylene/hexafluoropropylene copolymer, etc.

Especially preferred fluoropolymers are homopolymers of VDF, and copolymers of VDF with HFP, TFE or CTFE, comprising from about 50 to about 99 weight percent VDF, more preferably from about 70 to about 99 weight percent VDF. Especially preferred copolymers are copolymers of VDF and HFP where the weight percent of VDF in the copolymer is from 50 to 99 weight percent, preferably from 65 to 95 weight percent based on total monomers in the copolymer. In one preferred embodiment of a VDF/HFP copolymer the weight percent of HFP is from 5 to 30%, preferably from 8 to 25% based on the total monomer in the polymer.

Especially preferred terpolymers are the terpolymer of VDF, HFP and TFE, and the terpolymer of VDF, trifluoroethylene, and TFE. The especially preferred terpolymers have at least 10 weight percent VDF, and the other comonomers may be present in varying portions.

The fluoropolymer preferably has a high molecular weight. By high molecular weight, as used herein, is meant PVDF having a melt viscosity of greater than 1.0 kilopoise, preferably greater than 5 kilopoise, more preferably greater than 10 kilopoise, according to ASTM method D-3835 measured at 232 C (450° F.) and 100 sec⁻¹.

The fluoropolymers used in the invention can be made by means known in the art, such as by an emulsion, suspension, solution, or supercritical CO2 polymerization process. Preferably, the fluoropolymer is formed by an emulsion process. Preferably, the process is fluoro-surfactant free.

In a preferred embodiment, the fluoropolymer seed contains from 0.1 to 25 weight percent of monomeric units containing functional groups, and preferably from 2 to 20 weight percent, based on the total weight of polymer binder. The functional groups aid in adhesion of the polymer binder, and optional inorganic or organic particles to the separator.

The functional groups of the invention are preferably part of a fluoropolymer, due to the durability of fluoropolymers in the battery environment compared to polyolefins and other thermoplastic binder polymers.

The fluoropolymer seed may be functionalized by copolymerization using 0.1 to 25 weight percent, 0.2 to 20 weight percent, 2 to 20 weight percent, preferably 0.5 to 15 weight percent, and more preferably 0.5 to 10 weight percent of at least one functional comonomer. The copolymerization could add one or more functional comonomers to the fluoropolymer backbone, or be added by a grafting process. The seed fluoropolymer could also be functionalized by polymerized using from 0.1 to 25 weight percent of one or more low molecular weight polymeric functional chain transfer agents. By low molecular weight is meant a polymer with a degree of polymerization of less than or equal to 1,000, and preferably less than 800. The low molecular weight functional chain transfer agent is a polymer or an oligomer having two or more monomer units, and preferably at three or more monomer units, as for example poly acrylic acid. The residual polymeric chain transfer agents forming a block copolymer having terminal low molecular weight functional blocks. The seed fluoropolymer could have both functional comonomer and residual functional polymeric chain transfer agents.

The useful functional comonomers generally contain polar groups, or are high surface energy. Examples of some useful comonomers include, but are not limited to vinyl acetate, 2,3,3,3-tetrafluoropropene (HFO-1234yf), 2,3,3 trifluoropropene, hexafluoropropene (HFP), and 2-chloro-1-1-difluoroethylene (R-1122). HFP provides good adhesion. Phosphate (meth)acrylates, (meth) acrylic acid, and hydroxyl-functional (meth)acrylic comonomers could also be used as the functional comonomer.

By functional polymeric chain transfer agents, as used in the invention, is meant that the low molecular weight polymer chain transfer agent contains one or more different functional groups.

### Acrylic Portion

According to this invention, there is provided an aqueous fluorine-containing polymer dispersion having particle diameters of 0.05-3 μm, obtained by emulsion-polymerizing 5-95 parts by weight of a monomer mixture consisting of at least one monomer selected from the group consisting of alkyl acrylates whose alkyl groups have 1-18 carbon atoms and alkyl methacrylates whose alkyl groups have 1-18 carbon atoms and optionally an ethylenically unsaturated compound copolymerizable with the alkyl acrylates and the alkyl methacrylates, in an aqueous medium in the presence of 100 parts by weight of particles of a vinylidene fluoride polymer.

The alkyl acrylate with an alkyl group having 1-18 carbon atoms, used as one monomer to be emulsion-polymerized in the presence of the vinylidene fluoride polymer particles, includes, for example, methyl acrylate, ethyl acrylate, propyl acrylate, n-butyl acrylate, isobutyl acrylate, amyl acrylate, isoamyl acrylate, hexyl acrylate, 2-ethylhexyl acrylate, diacetone acrylamide, lauryl acrylate and the like. Of these, alkyl acrylates with an alkyl group having 1-8 carbon atoms are preferred, and alkyl acrylates with an alkyl group having 1-5 carbon atoms are more preferable. These compounds may be used alone or in admixture of two or more.

The alkyl methacrylate with an alkyl group having 1-18 carbon atoms, used as the other monomer to be emulsion-polymerized, includes, for example, methyl methacrylate, ethyl methacrylate, propyl methacrylate, n-butyl methacrylate, isobutyl methacrylate, amyl methacrylate, isoamyl methacrylate, hexyl methacrylate, lauryl methacrylate and the like. Of these, alkyl methacrylates with an alkyl group having 1-8 carbon atoms are preferred, and alkyl methacrylates with an alkyl group having 1-5 carbon atoms are more preferable. These compounds may be used alone or in admixture of two or more.

The optional ethylenically unsaturated compound copolymerizable with the alkyl acrylate and the alkyl methacrylate includes (A) a functional group-containing alkenyl compound and (B) a functional group-free alkenyl compound.

The functional group-containing alkenyl compound (A) includes, for example, α,β-unsaturated carboxylic acids such as acrylic acid, methacrylic acid, fumaric acid, crotonic acid, itaconic acid and the like; vinyl ester compounds such as vinyl acetate and the like; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide and the like; acrylic acid esters such as 2-hydroxyethyl acrylate, N-dialkylaminoethyl acrylate, glycidyl acrylate, fluoroalkyl acrylate and the like; methacrylic acid esters such as dialkylaminoethyl methacrylate, fluoroalkyl methacrylate, 2-hydroxyethyl methacrylate, glycidyl methacrylate, ethylene glycol dimethacrylate and the like; and alkenyl glycidyl ether compounds such as allyl glycidyl ether and the like. Of these, preferred are acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether. These compounds may be used alone or in admixture of two or more.

The functional group-free alkenyl compound (B) includes, for example, conjugated dienes such as 1,3-butadiene, isoprene and the like; aromatic alkenyl compounds such as styrene, α-methylstyrene, styrene halides and the like; divinyl hydrocarbon compounds such as divinyl benzene and the like; and alkenyl cyanides such as acrylonitrile, methacrylonitrile and the like. Of these, preferred are 1,3-butadiene, styrene and acrylonitrile. These compounds may be used alone or in admixture of two or more.

It is preferable that the functional alkenyl compound (A) be used in a proportion of less than 50% by weight based on the weight of the monomer mixture and the functional group-free alkenyl compound (B) be used in a proportion of less than 30% by weight based on the weight of the monomer mixture.

When both the alkyl acrylate and the alkyl methacrylate are used, the proportions of these two esters are not critical and can be appropriately varied depending upon the desired properties of the resulting fluorine-containing polymer.

Those of skill in the art will also recognize that any of the known acrylic monomers and ethylenically unsaturated monomers known to be copolymerizable with acrylic monomers may be substituted as long as one such monomer is included which contains functional groups capable of entering into crosslinking reactions. With the proviso that the major portion of the monomers must be selected from acrylic esters and methacrylic esters and at least one of the remaining selected monomers must be capable of entering into a crosslinking reaction.

### Cross Linkers

The acrylic modified fluoropolymer resin used may crosslink either through self-condensation of its functional groups or through reaction with a catalyst and/or a crosslinking agent, such as melamine resins, epoxy resins and the like, as well as known, low molecular weight crosslinkers such as di- or higher polyisocyanates, polyaziridines, polycarbodiimides, polyoxazolines, dialdehydes such as glyoxal, di- and trifunctional acetoacetates, malonates, acetals, thiols and acrylates, cycloaliphatic epoxy molecules, organosilanes such as epoxysilanes and amino silanes, carbamates, diamines, and triamines, inorganic chelating agents such as certain zinc and zirconium salts, titantes, glycourils and aother aminoplasts. In some cases, functional groups from other polymerization ingredients, such as surfactant, initiator, seed particle may be involved in the crosslinking reaction. When two or more functional groups are involved in the crosslinking process, illustrative pairs of complementary reactive groups are, for example, hydroxyl-isocyanate, acid-epoxy, amine-epoxy, hydroxyl-melamine, acetoacetate-acid, Other complementary functional groups are well known in the art and are contemplated as equivalents by this invention. One of skill in the art will understand the resins contemplated by this invention crosslink through self condensation (self reaction) or by the use of external crosslinking agents with or without the use of catalysts. It will also be apparent that crosslinking may occur by reaction of two different functional groups on the same molecule or on different molecules. Catalysts function in the usual way to either accelerate curing or lower the required curing temperature.

The acrylate and/or methacrylate monomers not containing functional groups capable of entering into crosslinking reactions after polymerization, preferably should be 70 or greater weight percent of the total monomer mixture, and more preferably, should be above 90 weight percent.

### Emulsion Polymerization

The aqueous fluoropolymer-acrylic composition can be obtained by emulsion-polymerizing 5-100 parts by weight, particularly preferably 5 to 95, preferably 20-90 parts by weight, of the acrylic monomer(s) mentioned above, in an aqueous medium in the presence of 100 parts by weight of the vinylidene fluoride polymer particles mentioned above. The emulsion-polymerization can be effected under ordinary emulsion polymerization conditions. The emulsion polymerization process is known in the art. The emulsion-polymerization using the fluoropolymer particle, preferably vinylidene fluoride polymer particles, as seed particles can be effected according to a known method, for example, a method wherein the whole amount of the monomers is fed into the reaction system at one time in the presence of fluoropolymer particle, preferably vinylidene fluoride polymer particles, a method wherein part of the monomers are fed and reacted and then the rest of the monomers is fed continuously or in portions, a method wherein the whole amount of the monomers is fed continuously, or a method wherein the fluoro polymer particles are added in portions or continuously while allowing the monomers to react.

The fluoropolymer particles, preferably vinylidene fluoride polymer particles may be added in any state to the polymerization system as long as they are dispersed in an aqueous medium in the form of particles. Since the vinylidene fluoride polymer is usually produced as an aqueous dispersion, it is convenient that the aqueous dispersion as produced be used as seed particles. The particle diameters of the fluoropolymer particle, preferably vinylidene fluoride polymer particles, may vary depending upon the diameters of polymer particles present in an objective aqueous dispersion of said polymer but ordinarily is in the range of preferably 0.04-2.9 microns. In a preferred embodiment, the diameter of the polymer particles is preferably 50 nm to 700 nm.

It is thought that the monomer mixture is mostly absorbed or adsorbed by the fluoropolymer particle, preferably vinylidene fluoride polymer particles and polymerized while swelling the particles.

The average particle diameter of the fluorine-containing polymer in the aqueous dispersion of said polymer according to this invention is 0.05-3 μm, preferably 0.05-1 μm, more preferably 0.1-1 μm. When the average particle diameter is less than 0.05 μm, the resulting aqueous dispersion has a high viscosity; accordingly, it is impossible to obtain an aqueous dispersion of a high solid content, and a coagulation product is formed when the mechanical shear conditions are severe depending upon the use conditions. When the average particle diameter is more than 3 μm, the aqueous dispersion has poor storage stability.

Though the aqueous dispersion containing the crosslinkable AMF polymer can be used as it is, it may also be mixed with additives and then used.

The product of the polymerization is a latex which can be used in that form, usually after filtration of solid byproducts from the polymerization process, or which can be coagulated to isolate the solids, which may then be washed and dried. For use in latex form, the latex can be stabilized by the addition of a surfactant, which may be the same as or different from the surfactant present during polymerization (if any). This later added surfactant may, for example, be an ionic or non-ionic surfactant. In one embodiment of the invention, no fluorosurfactant is added to the latex. For solid product, the latex may be coagulated mechanically or by the addition of salts or acids, and then isolated by well-known means such as by filtration. Once isolated, solid product can be purified by washing or other techniques, and it may be dried for use as a powder, which can be further processed into granules, pellets or the like.

The fluoropolymer acrylic composition is applied to a substrate, as a latex in water or as a solvent solution, the solvent being chosen among those listed herein.

In one embodiment, said substrate is porous, for example a porous membrane.

### Inorganic Particles

The binder composition may optionally contain, and preferably does contain inorganic particles, which serve to form micropores and to maintain the physical shape as spacers in the separator coating. The inorganic particles also aid in heat resistance of the battery components.

In a separator coating, the inorganic particles are powdery particulate materials, which must be electrochemically stable (not subjected to oxidation and/or reduction at the range of drive voltages). Moreover, the powdery inorganic materials preferably have a high ion conductivity. Materials of low density are preferred over higher density materials, as the weight of the battery produced can be reduced. The dielectric constant is preferably 5 or greater. The inorganic powdery materials is usually ceramics. Useful inorganic powdery materials in the invention include, but are not limited to BaTiO₃, Pb(Zr,Ti)O₃, Pb₁₋ₓLaₓZr_{y}O₃ (0<x<1, 0<y<1), PBMg₃Nb_{2/3})₃, PbTiO₃, hafnia (HfO(HfO₂), SrTiO₃, SnO₂, CeO₂, MgO, NiO, CaO, ZnO, Y₂O₃, bohemite (y-AlO(OH)), Al₂O₃, SiC, ZrO₂, boron silicate, BaSO₄, nano-clays, or mixtures thereof. Useful organic fibers, include, but are not limited to aramid fillers and fibers, polyetherether ketone and polyetherketone ketone fibers, PTFE fibers, and nanofibers.

The ratio of polymer solids to inorganic material is from 0.5-25 parts by weight of polymer binder solids to 75 to 99.5 parts by weight powdery inorganic material, preferably from 0.5-15 parts by weight of polymer binder solids to 85 to 99.5 parts by weight powdery inorganic material, more preferably from 1-10 parts by weight of polymer binder solids to 90 to 99 parts by weight powdery material, and in one embodiment from 0.5-8 parts by weight of polymer binder solids to 92 to 99.5 parts by weight powdery inorganic material. If less polymer is used, complete interconnectivity may not be achieved. One use of the composition is for very small and light batteries therefore excess polymer is not desired as the composition takes up volume and adds weight.

### Other Additives

The binder composition of the invention may optionally include 0 to 15 weight percent based on the polymer, and preferably 0.1 to 10 weight percent of additives, including but not limited to thickeners, pH adjusting agents, anti-settling agents, surfactants, wetting agents, fillers, anti-foaming agents, and fugitive adhesion promoters.

The binder composition of the invention has excellent dry adhesion. Dry adhesion can be determined by casting a solution of multi-phase polymer on an aluminum foil to form a 3 micron thick solid, unfilled polymer film after drying, and measuring the peel strength.

Wet adhesion can be determined by soaking the 3 micron solid film on aluminum foil in electrolyte solution at 60 C for 72 hr and looking for defects and delamination. Formation of a coated separator

Use as a separator coating: A porous separator is coated on at least one side with a coating composition comprising the crosslinking AMF polymer of the invention. There is no particular limitation in choosing the separator substrate that is coated with the aqueous coating composition of the invention, as long as it is a porous substrate having pores. Preferably, the substrate is a heat resistant porous substrate having a melting point of greater than 120° C. Such heat resistant porous substrates can improve the thermal safety of the coated separator under external and/or internal thermal impacts.

The porous substrate may take the form of a membrane, or fibrous web. Porous substrates used for separators are known in the art.

Examples of porous substrates useful in the invention as the separator include, but are not limited to, polyolefins, polyethylene terephthalate, polybutylene terephthalate, polyester, polyacetal, polyamide, polycarbonate, polyimide, polyetherether ketone, polyether sulfone, polyphenylene oxide, polyphenylene sulfido, polyethylene naphthalene or mixtures thereof. Other heat resistant engineering plastics may be used with no particular limitation. Non-woven materials of natural and synthetic materials may also be used as the substrate of the separator.

The binder can be applied to the separator in its latex form or can be blended with the inorganic particles or other additives and then applied. The polymer binder and also be dissolve in a solvent and then applied to the separator or can be dissolved in a solvent and blended with the inorganic particles or other additives and then applied.

The binder coating composition can be a solution, solvent dispersion, or aqueous dispersion, which is applied onto at least one surface of a porous substrate by means known in the art, such as by brush, roller, ink jet, dip, knife, gravure, wire rod, squeegee, foam applicator, curtain coating, vacuum coating, or spraying. The coating is then dried onto the separator at room temperature, or at an elevated temperature. The final dry coating thickness is from 0.5 to 15 microns, preferably from 1 to 8 microns, and more preferably from 1 to 5 microns in thickness.

The coated separators of the invention can be used to form an electrochemical device, such as a battery, capacitor, electric double layer capacitor, membrane electrode assembly (MEA) for fuel cell, by means known in the art. A non-aqueous-type battery can be formed by placing a negative electrode and positive electrode on either side of the coated separator.

### ASPECTS OF THE INVENTION

Aspect 1. A coated separator for a lithium ion battery comprising an adhesive layer (binder coating) on at least one side of a separator, wherein the adhesive layer comprises a fluoropolymer-acrylic composition, wherein said composition comprises a fluoropolymer-acrylic resin, the resin comprising from 5 to 50 wt % acrylic monomer units based upon the total weight of the fluoropolymer-acrylic resin, wherein the resin is cross linked, wherein the resin is a composition comprising an acrylic monomer polymerized in the presence of a fluoropolymer seed.

Aspect 2. The coated separator of aspect 1, wherein the fluoropolymer seed comprises at least one monomer selected from the group consisting of vinylidenefluoride (VDF), tetrafluoroethylene (TFE), trifluoroethylene (VF3), chlorotrifluoroethylene (CTFE), hexafluoropropene (HFP), vinyl fluoride (VF), hexafluoroisobutylene, perfluorobutylethylene (PFBE), pentafluoropropene, 2,3,3,3-tetrafluoropropene (HFO-1234yf), 2-chloro-1-1-difluoroethylene (R-1122), 3,3,3-trifluoro-1-propene, 2-fluoromethyl-3,3,3-trifluoropropene, a fluorinated vinyl ether, a fluorinated allyl ether, a non-fluorinated allyl ether, a fluorinated dioxole or combinations thereof.

Aspect 3. The coated separator of aspect 1, wherein the fluoropolymer seed comprises a vinylidenefluoride polymer, preferably at least 50 weight percent VDF, preferably at least 70 weight percent VDF.

Aspect 4. The coated separator of any one of aspects 1 to 3, wherein the fluoropolymer seed comprises from 3 to 30 wt % hexafluoropropylene.

Aspect 5. The coated separator of aspect 1, wherein the seed comprises a polyvinylidene fluoride-hexafluoropropylene copolymer, wherein the total weight percent of hexafluoropropylene monomeric units in the fluoropolymer-acrylic resin is from 5 to 20%, preferably from 10 to 20 wt % based on the total weight percent of polymer in the adhesive layer.

Aspect 6. The coated separator of any one of aspects 1 to 5, wherein the total weight percent of acrylic monomeric units in the fluoropolymer-acrylic resin is from 15 to 40 wt %.

Aspect 7. The coated separator of any one of aspects 1 to 6, wherein the acrylic polymer contains monomers that contain functional groups that can crosslink.

Aspect 8. The coated separator of any one of aspects 1 to 6, wherein the acrylic polymer contains monomer selected from the group consisting of ethylacrylate (EA), methyl acrylate (MA), butyl acrylate (BA), allyloxy propane diol (AOPD), amylacrylate, 2-ethylhexylacrylate, hexylacrylate, ethyl methacrylate (EMA), methyl methacrylate (MMA), butyl methacrylate, propyl methacrylate, isobutylmediacrylate, amyl methacrylate, 2-ethyl hexyl methacrylate, aceto acetoxy ethylmethacrylate (AEA or AAEM); of this group ethylacrylate, methylacrylate, butyl acrylate and methyl methacrylate are preferred; α,β-unsaturated carboxylic acids (acrylic acid or AA, methacrylic acid (maa or MAA), fumaric acid, crotonic acid, itaconic acid or IA), vinyl ester compounds, amide compounds (acrylamide, methacrylamide, N-alkyl methacrylamide, N-methylol methacrylamide or NMA, acrylamide, N-dialkyl methacrylamide, N-dialkyl acrylamide, isobutoxy methacrylamide (IBMA or iBMA)), ethylenically unsaturated monomers containing hydroxyl groups (hydroxylethyl methacrylate or HEMA hydroxyethyl acrylate, hydroxypropyl acrylate, hydroxypropyl methacrylate, diethylene glycol ethyl acrylate or DGEA for example), monomers containing epoxy groups (glycidyl acrylate, glycidyl methacrylate or GMA, for example), monomers containing silanols (γ trimethoxysilane methacrylate, γ triethoxysilane methacrylate, trimethyl silyl propyl acrylate (TMPA or TMSPA), for example), monomers containing aldehyde functions, such as acrolein, alkenyl cyanides, such as acrylonitrile methacrylonitrile and combinations thereof.

Aspect 9. The coated separator of any one of aspects 1 to 6, wherein the acrylic polymer contains monomer selected from the group consisting of α,β-unsaturated carboxylic acids such as acrylic acid, methacrylic acid, fumaric acid, crotonic acid, itaconic acid; vinyl ester compounds such as vinyl acetate; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide; acrylic acid esters such as 2-hydroxyethyl acrylate, N-dialkylaminoethyl acrylate, glycidyl acrylate, fluoroalkyl acrylate; methacrylic acid esters such as dialkylaminoethyl methacrylate, fluoroalkyl methacrylate, 2-hydroxyethyl methacrylate, glycidyl methacrylate, ethylene glycol dimethacrylate; and alkenyl glycidyl ether compounds such as allyl glycidyl ether.

Aspect 10. The coated separator of any one of aspects 1 to 6, wherein the acrylic polymer contains monomer selected from the group consisting of acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether.

Aspect 11. The coated separator of any one of aspects 1 to 6, wherein at least one or more of the acrylic monomers is selected from the group consisting of methyl methacrylate, methacrylic acid, methacrylate, 2-hydroxyethyl methacrylate, 4-hydroxybutyl methacrylate, ethyl acrylate, butyl acrylate, propyl acrylate, acrylic acid, diacetone acrylamide, polymethoxydiethylene glycol (meth)acrylate, and combination thereof.

Aspect 12. The coated separator of any one of aspects 1 to 11, wherein the porous separator is made of a polymer selected for the group consisting of polyethylene, polypropylene, polypropylene-polyethylene-polypropylene, and polyvinylidene fluoride.

Aspect 13. The coated separator of any one of aspects 1 to 12, herein the thickness of the adhesive layer coating at least one side of the separator is from 0.5 to 10 micrometers.

Aspect 14. The coated separator of any one of aspects 1 to 13, herein the fluoropolymer-acrylic resin is self cross linking.

Aspect 15 The coated separator of any one of aspects 1 to 13, herein the fluoropolymer-acrylic composition comprises a cross-linking agent.

Aspect 16. The coated separator of aspects 15, herein the crosslinking agent is selected from the group consisting of melamine resins, epoxy resins, isocyanate, di- or higher polyisocyanates, polyaziridines, polycarbodiimides, polyoxazolines, dialdehydes such as glyoxal, di- and trifunctional acetoacetates, malonates, acetals, thiols and acrylates, cycloaliphatic epoxy molecules, carbamates, diamines, and triamines inorganic chelating agents such as certain zinc and zirconium salts titantes, glycourils and aother aminoplastsisocyanate, diamine, adipic acid, dihydrazide, and combinations thereof.

Aspect 17. The coated separator of aspect 15, herein the crosslinking agent is selected from the group consisting of isocyanate, diamine, adipic acid, dihydrazide, and combinations thereof.

Aspect 18. The coated separator of any one of aspects 1 to 17, herein said adhesive layer further comprises 50 to 99 weight percent of inorganic particles, based on the combined weight of polymer and inorganic particles, wherein said inorganic particles being electrochemically stable inorganic particles.

Aspect 19. The coated separator of any one of aspects 1 to 17, herein said adhesive layer further comprises 50 to 99 weight percent of inorganic particles, based on the combined weight of polymer and inorganic particles, wherein said inorganic particles being electrochemically stable inorganic particles, and said inorganic particles are selected from the group consisting of BaTiO₃, Pb(Zr,Ti)O₃, Pb₁₋ₓLaₓZr_{y}O₃ (0<x<1, 0<y<1), PBMg₃Nb_{2/3})₃,PbTiO₃, hafnia (HfO(HfO₂), SrTiO₃, SnO₂, CeO₂, MgO, NiO, CaO, ZnO, Y₂O₃, bohemite (y-AlO(OH)), Al₂O₃, SiO₂, SiC, ZrO₂, boron silicate, BaSO₄, nano-clays, or mixtures thereof.

Aspect 20. The coated separator of any one of aspects 1 to 17, wherein said adhesive layer further comprises 50 to 99 weight percent of inorganic particles, based on the combined weight of polymer and inorganic particles, wherein said inorganic particles being electrochemically stable inorganic particles, and said inorganic particles are selected from the group consisting of MgO, bohemite (y-AlO(OH)), Al₂O₃, nano-clays, or mixtures thereof.

Aspect 21. The coated separator of any one of aspects 1 to 20, wherein said fluoropolymer-acrylic resin comprises discrete resin particles having an average particle size of less than 1 micrometer, and preferably less than 500 nm, preferably less than 400 nm, preferably less than 300 nm.

Aspect 22. The coated separator of any one of aspects 1 to 20, wherein said fluoropolymer-acrylic resin comprises a film formed from a polymer dissolved in a solvent.

Aspect 23. The coated separator of aspect 22 wherein the solvent is selected from the group consisting of n-methylpyrrolidone (NMP), dimethylsulfoxide (DMSO), N,N-dimethylformamide (DMF), triethylphosphite (TEP), acetone, cyclopentanone, tetrahydrofuran, methyl ethylketone (MEK), methyl isobutyl ketone (MiBK), ethyl acetate (EA), butyl acetate (BA), ethylene carbonate (EC), propylene carbonate (PC), dimethyl carbonate (DMC), diethyl carbonate (DEC), ethyl methyl carbonate (EMC) or combination s thereof.

Aspect 24. A battery comprising an anode, a cathode and the separator of any of aspects 1 to 22.

Aspect 25. A component of an electrochemical device, wherein said component has directly coated on at least one side thereof a dried crosslinked fluoropolymer-acrylic composition, wherein the fluoropolymer-acrylic composition comprises a fluoropolymer-acrylic resin, the resin comprising from 5 to 50 wt % acrylic monomer units based upon the total weight of the fluoropolymer-acrylic resin, wherein the resin is a composition comprising an acrylic monomer polymerized in the presence of a fluoropolymer seed,

wherein said coated component is a separator or electrode;

wherein said dried, fluoropolymer-acrylic composition has a dry adhesive strength of greater than 10 N/m, preferably greater than 15 N/m, as measured by 180 degree peel strength measurement.

Aspect 26. A method for forming a coated separator comprising

a) the steps of dip-coating, spray coating, micro-gravure coating or slot coating at least one side of a separator with a crosslinking fluoropolymer-acrylic composition,
b) drying said coated separator at a temperature of from 25 to 85 C, to form a dried adhesive layer, on the separator, wherein the composition comprises a fluoropolymer-acrylic resin, the resin having and from 5 to 50 wt % acrylic monomer units based upon the total weight of the fluoropolymer-acrylic resin, wherein the resin is a composition comprising an acrylic monomer polymerized with a fluoropolymer seed.

Aspect 27. The method of aspect 26, wherein the fluoropolymer seed comprises at least one monomer selected from the group consisting of vinylidenefluoride (VDF), tetrafluoroethylene (TFE), trifluoroethylene (VF3), chlorotrifluoroethylene (CTFE), hexafluoropropene (HFP), vinyl fluoride (VF), hexafluoroisobutylene, perfluorobutylethylene (PFBE), pentafluoropropene, 2,3,3,3-tetrafluoropropene (HFO-1234yf), 2-chloro-1-1-difluoroethylene (R-1122), 3,3,3-trifluoro-1-propene, 2-fluoromethyl-3,3,3-trifluoropropene, a fluorinated vinyl ether, a fluorinated allyl ether, a non-fluorinated allyl ether, a fluorinated dioxole or combinations thereof.

Aspect 28. The method of aspect 26, wherein the fluoropolymer seed comprises a vinylidenefluoride polymer, preferably at least 50 weight percent VDF, preferably at least 70 weight percent VDF.

Aspect 29. The method of any one of aspects 26 to 28, wherein the fluoropolymer seed comprises from 3 to 30 wt % hexafluoropropylene.

Aspect 30. The method of aspect 26, wherein the seed comprises a polyvinylidene fluoride-hexafluoropropylene copolymer, wherein the total weight percent of hexafluoropropylene monomeric units in the fluoropolymer-acrylic resin is from 5 to 20%, preferably from 10 to 20 wt % based on the total weight percent of polymer in the adhesive layer.

Aspect 31. The method of any one of aspects 26 to 30, wherein the total weight percent of acrylic monomeric units in the fluoropolymer-acrylic resin is from 15 to 40 wt %.

Aspect 32. The method of any one of aspects 26 to 31, wherein the acrylic polymer contains monomers that contain functional groups that can crosslink.

Aspect 33. The method of any one of aspects 26 to 31, wherein the acrylic polymer contains monomer selected from the group consisting of ethylacrylate (EA), methyl acrylate (MA), butyl acrylate (BA), allyloxy propane diol (AOPD), amylacrylate, 2-ethylhexylacrylate, hexylacrylate, ethyl methacrylate (EMA), methyl methacrylate (MMA), butyl methacrylate, propyl methacrylate, isobutylmethacrylate, amyl methacrylate. 2-ethyl hexyl methacrylate, aceto acetoxy ethylmethacrylate (AEA or AAEM); of this group ethylacrylate, methylacrylate, butyl acrylate and methyl methacrylate are preferred; α,β-unsaturated carboxylic acids (acrylic acid or AA, methacrylic acid (maa or MAA), fumaric acid, crotonic acid, itaconic acid or IA), vinyl ester compounds, amide compounds (acrylamide, methacrylamide, N-alkyl methacrylamide, N-methylol methacrylamide or NMA, acrylamide. N-dialkyl methacrylamide, acrylamide, isobutoxy methacrylamide (IBMA or iBMA)), ethylenically unsaturated monomers containing hydroxyl groups (hydroxylethyl methacrylate or HEMA, hydroxyethyl acrylate, hydroxypropyl acrylate, hydroxypropyl methacrylate, diethylene glycol ethyl acrylate or DGEA for example), monomers containing epoxy groups (glycidyl acrylate, glycidyl methacrylate or (MA, for example), monomers containing silanols (γ trimethoxysilane methacrylate, γ triethoxysilane methacrylate, trimethyl silyl propyl acrylate (TMPA or TMSPA), for example), monomers containing aldehyde, functions, such as acrolein, alkenyl cyanides, such as acrylonitrile methacrylonitrile and combinations thereof.

Aspect 34. The method of any one of aspects 26 to 31, wherein the acrylic polymer contains monomer selected from the group consisting of α,β-unsaturated carboxylic acids such as acrylic acid, methacrylic acid, fumaric acid, crotonic acid, itaconic acid; vinyl ester compounds such as vinyl acetate; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide; acrylic acid esters such as 2-hydroxyethyl acrylate, N-dialkylaminoethyl acrylate, glycidyl acrylate, fluoroalkyl acrylate; methacrylic acid esters such as dialkylaminoethyl methacrylate, fluoroalkyl methacrylate, 2-hydroxyethyl methacrylate, glycidyl methacrylate, ethylene glycol dimethacrylate; and alkenyl glycidyl ether compounds such as allyl glycidyl ether.

Aspect 35. The method of any one of aspects 26 to 31, wherein the acrylic polymer contains monomer selected from the group consisting of acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether.

Aspect 36. The method of any one of aspects 26 to 31, wherein at least one or more of the acrylic monomers is selected from the group consisting of methyl methacrylate, methacrylic acid, methacrylate, 2-hydroxyethyl methacrylate, 4-hydroxybutyl methacrylate, ethyl acrylate, butyl acrylate, propyl acrylate, acrylic acid, diacetone acrylamide, polymethoxydiethylene glycol (met h)acrylate, and combination thereof.

Aspect 37. The method of any one of aspects 26 to 36, wherein the porous separator is made of a polymer selected for the group consisting of polyethylene, polypropylene, polypropylene-polyethylene-polypropylene, and polyvinylidene fluoride.

Aspect 38. The method of any one of aspects 26 to 37, herein the thickness of the adhesive layer coating at least one side of the separator is from 0.5 to 10 micrometers.

Aspect 39. The method of any one of aspects 26 to 38, herein the fluoropolymer-acrylic resin is self cross linking.

Aspect 40. The method of any one of aspects 26 to 38, herein the fluoropolymer-acrylic composition comprises a cross-linking agent.

Aspect 41. The method of aspect 40, herein the crosslinking agent is selected from the group consisting of melamine resins, epoxy resins, isocyanate, di- or higher polyisocyanates, polyaziridines, polycarbodiimides, polyoxazolines, dialdehydes such as glyoxal, di- and trifunctional acetoacetates, malonates, acetals, thiols and acrylates, cycloaliphatic epoxy molecules, carbamates, diamine, and triamines, inorganic chelating agents such as certain zinc and zirconium salts, titantes, glycourils and aother aminoplastsisocyanate, diamine, adipic acid, dihydrazide, and combinations thereof.

Aspect 42. The method of aspect 40, herein the crosslinking agent is selected from the group consisting of isocyanate, diamine, adipic acid, dihydrazide, and combinations thereof.

Aspect 43. The method of any one of aspects 26 to 42, herein said adhesive layer further comprises 50 to 99 weight percent of inorganic particles, based on the combined weight of polymer and inorganic particles, wherein said inorganic particles being electrochemically stable inorganic particles.

Aspect 44. The method of any one of aspects 26 to 42, herein said adhesive layer further comprises 50 to 99 weight percent of inorganic particles, based on the combined weight of polymer and inorganic particles, wherein said inorganic particles being electrochemically stable inorganic particles, and said inorganic particles are selected from the group consisting of BaTiO₃, Pb(Zr,Ti)O₃, Pb₁₋ₓLaₓZr_{y}O₃ (0<x<1, 0<y<1), PBMg₃Nb_{2/3})₃, PbTiO₃, hafnia (HfO(HfO₂), SrTiO₃, SnO₂, CeO₂, MgO, NiO, CaO, ZnO, Y₂O₃, bohemite (y-AlO(OH)), Al₂O₃, SiO₂, SiC, ZrO₂, boron silicate, BaSO₄, nano-clays, or mixtures thereof.

Aspect 45. The method of any one of aspects 26 to 42, wherein said adhesive layer further comprises 50 to 99 weight percent of inorganic particles, based on the combined weight of polymer and inorganic particles, wherein said inorganic particles being electrochemically stable inorganic particles, and said inorganic particles are selected from the group consisting of MgO, bohemite (y-AlO(OH)), Al₂O₃, nano-clays, or mixtures thereof.

Aspect 46. The method of any one of aspects 26 to 45, wherein said fluoropolymer-acrylic resin comprises discrete resin particles having an average particle size of less than 3 micrometer, preferably less than 1 micrometer, preferably less than 500 nm, preferably less than 400 nm, preferably less than 300 nm.

Aspect 47. The method of any one of aspects 26 to 45, wherein said fluoropolymer-acrylic resin is dissolved in solvent prior to the coating step.

Aspect 48. The method of aspect 47 wherein the solvent is selected from the group consisting of n-methylpyrrolidone (NMP), dimethylsulfoxide (DMSO), N,N-dimethylformamide (DMF), triethylphosphite (TEP), acetone, cyclopentanone, tetrahydrofuran, methyl ethylketone (MEK), methyl isobutyl ketone (MiBK), ethyl acetate (EA), butyl acetate (BA), ethylene carbonate (EC), propylene carbonate (PC), dimethyl carbonate (DMC), diethyl carbonate (DEC), ethyl methyl carbonate (EMC) or combination s thereof.

Aspect 49. A coated separator for a lithium ion battery comprising an adhesive layer on at least one side of a porous separator, wherein the adhesive layer comprises a cross linked fluoropolymer-acrylic composition, wherein said composition comprises a fluoropolymer-acrylic resin, the resin comprising from 3 to 20 wt % hexafluoropropylene and from 5 to 50 wt % acrylic monomer units based upon the total weight of the fluoropolymer-acrylic resin, wherein the resin is a composition comprising an acrylic monomer polymerized with a vinylidenefluoride/hexafluoropropylene copolymer seed, wherein at least one, preferably at least two acrylic monomer(s) selected from the group consisting of methacrylic acid, methacrylate, 2-hydroxyethyl methacrylate, diacetone acrylamide, methyl methacrylate, ethyl acrylate, butyl acrylate and combination thereof, wherein said adhesive layer further comprises 50 to 99 weight percent of inorganic particles, based on weight of polymer binder plus inorganic particles, wherein said inorganic particles being electrochemically stable inorganic particles, and said inorganic particles are selected from the group consisting of MgO, bohemite (y-AlO(OH)), Al₂O₃, or mixtures thereof.

### EXAMPLES

### Adhesive Strength to Positive Electrode:

Preparation of positive electrode: 27.16 g of Nickel Manganese Cobalt 622 powder as the positive active material, 0.42 g of carbon black powder as the conductive agent, and 0.42 g of polyvinylidene fluoride as binder were mixed in 4.83 g of N-methyl-pyrrolidone. The resultant solution were mixed under high speed, e.g. 2000 rpm. The positive electrode slurry was coated onto aluminum foil, dried in the oven and calendared by press to achieve a positive electrode.

Sample preparation for peel test: The coated separator and positive electrode were cut into shape of 2.5 cm by 5 cm. The adhesive organic layer coated side of the separator was laminated into contact with the positive electrode side. Lamination was carried at 85° C. and 0.62 MPa for 2 min to adhere coated separator to positive electrode. After lamination, attach single sided tape as the backing support layer to the coated separator. Then cut the composite of single sided tape, coated separator, and positive electrode to 1.5 cm by width and 5 cm by length.

Adhesive strength test: Apply a double sided tape onto a thick block (e.g. thickness around 1 cm) of steel plate, attach the uncoated side of aluminum foil in the composite of electrode and coated separator to the double sided tape, and run the 180 degree peel test by peeling off the single sided tape and coated separator. The peel test was run under tension mode, with a load cell of 10 N and peeling speed of 2 mm/min. The trend that the higher the tested adhesion force, the more transferred electrode material to the coated separator would be observed.

Swelling test in electrolyte: Electrolyte consists of ethylene carbonate, dimethyl carbonate, and diethyl carbonate with ratio of 1:1:1 by volume was used. Samples were prepared either by drying from solution with organic solvent or by drying from solution with water. Swelling test was carried at 60° C. with dried samples submerged completely in the electrolyte for 72 hours. Weight of the sample was measured before swelling test (m1) as well as after the swelling test (m2). Then the swelling ratio was characterized as (m2−m1)/m1*100%.

### Example 1

A polyvinylidene fluoride-hexafluoropropylene (PVDF-HFP) copolymer latex was used as seed to synthesize a latex containing fluoropolymer-acrylic composition using emulsion polymerization process. Solids content of this latex is about 50 wt %. The mass percent of the HFP part in the PVDF-HFP copolymer is around 20 to 22 wt % and the acrylic part is about 50 wt % in total polymer. The acrylic part contains crosslinkable functional groups. The acrylic part has a glass transition temperature of −25° C.

The fluoropolymer-acrylic composition was directly used as latex (in water).

The slurry was applied to the porous separator, and dried at 60° C. (for latex slurry). The dried thickness of the adhesive layer is in the range of 1 to 2 μm. The adhesive strength of separator coated with fluoropolymer-acrylic composition in example 1 to cathode was 55.1 N/m for latex slurry. The average swelling ratio of the fluoropolymer-acrylic composition in electrolyte was 500%.

### Example 2: Crosslinked AMF Polymer

A polyvinylidene fluoride-hexafluoropropylene (PVDF-HFP) copolymer latex was used as seed to synthesize a latex containing fluoropolymer-acrylic composition using emulsion polymerization process. Solids content of this latex is around 44 wt %. The mass percent of the HFP part in the PVDF-HFP copolymer is around 20 to 22 wt % and the acrylic part is around 30 wt % in total polymer and contained cross linkable groups. The acrylic part has a glass transition temperature of 46° C.

The fluoropolymer-acrylic composition was dissolved in solvent of cyclopentanone and the solution concentration was 10 wt % by mass.

The slurry was applied to the porous separator, and dried at 60° C. oven. The dried thickness of the adhesive layer is in the range of 1 to 2 μm. The adhesive strength of separator coated with the fluoropolymer-acrylic composition in example 2 to cathode was averaged as 31.8 N/m and the average swelling ratio of the fluoropolymer-acrylic composition in electrolyte was 900 wt %.

### Example 3: Blend of Crosslinkable AMF Polymer with VDF/HFP Copolymer

Except that fluoropolymer-acrylic composition in Example 2 was mixed with polyvinylidene fluoride-hexafluoropropylene (PVDF-HFP, with 10% HFP) copolymer to yield a composition containing 25 wt % of acrylic, the same procedure was carried out in Example 2 to coat separators.

The adhesive strength of separator coated with material in Example 3 to cathode was averaged as 17.1 N/m and the swelling ratio of the material in electrolyte was 650 wt %.

### Comparative Example 1: PVDF Copolymer—No Acrylic

A polyvinylidene fluoride-hexafluoropropylene (PVDF-HFP) copolymer was dissolved in cyclopentanone and the solution concentration was 10 wt % by mass. The mass percent of the HFP part in the PVDF-HFP copolymer is around 4 to 6 wt %. The copolymer was dissolved in solvent of cyclopentanone and the solution concentration was 10 wt % by mass.

The slurry was applied to the porous separator, and dried at 60° C. oven. The dried thickness of the adhesive layer is in the range of 1 to 2 μm. The adhesive strength of separator coated with material in Comparative Example 1 to cathode was below 3 N/m and the swelling ratio of the material in electrolyte was averaged as 160 wt %.

### Comparative Example 2: Not Crosslinked

A polyvinylidene fluoride-hexafluoropropylene (PVDF-HFP) copolymer latex was used as seed to synthesize a latex containing fluoropolymer-acrylic composition using emulsion polymerization process. Solids content of this latex is around 44 wt %. The mass percent of the HFP part in the PVDF-HFP copolymer is around 20 to 22 wt % and the acrylic part is around 30 wt % in total polymer. The acrylic part has a glass transition temperature of 55° C.

The fluoropolymer-acrylic composition was dissolved in solvent of cyclopentanone and the solution concentration was 10 wt % by mass.

The slurry was applied to the porous separator, and dried at 60° C. oven. The dried thickness of the adhesive layer is in the range of 1 to 2 μm. The adhesive strength of separator coated with fluoropolymer-acrylic composition in Comparative Example 2 to cathode was averaged as 13.7 N/m and the material in Example 2 dissolved in electrolyte.

### Comparative Example 3: (Physical Blend) not Crosslinked

Polyvinylidene fluoride-hexafluoropropylene (PVDF-HFP) copolymer was mixed with acrylic type resin to yield acrylic mass ratio of 30 wt % and HFP content in the PVDF-HFP copolymer is around 8 to 10 wt %. The acrylic type resin has a glass transition temperature of about 70° C.

The material was dissolved in solvent of cyclopentanone and the solution concentration was 10 wt % by mass. The adhesive strength of separator coated with material in Comparative Example 3 to cathode was below 3 N/m and part of the material of dissolved in electrolyte as indicated by a mass loss.

TABLE 2

| | | | | Tg of | | Adhesive | |
|---|---|---|---|---|---|---|---|
| | Solids | HFP | Acrylic | Acrylic | 1 to 2 | strength | Swelling |
| Example | content | wt % | wt % | ° C. | micron | N/m | Wt % |
| 1 | 50 | 21 | 30 | | | 55.1 | 500 |
| 2 | 44 | 21 | 30 | 46 C. | | 31.8 | 900 |
| 3 | 20 | 9 | 25 | 46 | | 17.1 | 650 |
| Comparative 1 | | 5 | 0 | | | 3 | 160 |
| Comparative 2 | 44 | 21 | 30 | 55 | | 13.7 | dissolved |
| Comparative 3 | | 30 | 9 | 70 | | 3 | Partially |
| BLEND | | | | | | | dissolved |

1. A coated separator for a lithium ion battery comprising an adhesive layer (binder coating) on at least one side of a separator, wherein the adhesive layer comprises a fluoropolymer-acrylic composition, wherein said composition comprises a fluoropolymer-acrylic resin, the resin comprising from 5 to 50 wt % acrylic monomer units based upon the total weight of the fluoropolymer-acrylic resin, wherein the resin is cross linked, wherein the resin is a composition comprising an acrylic monomer polymerized in the presence of a fluoropolymer seed.

2. (canceled)

3. The coated separator of claim 1, wherein the fluoropolymer seed comprises a vinylidene fluoride polymer comprising at least 50 weight percent VDF.

4. The coated separator of claim 1, wherein the fluoropolymer seed comprises a polyvinylidene fluoride-hexafluoropropylene copolymer, wherein the total weight percent of hexafluoropropylene monomeric units in the fluoropolymer-acrylic resin is from 5 to 20 wt % based on the total weight percent of fluoropolymer-acrylic resin in the adhesive layer.

5. The coated separator of claim 1, wherein the fluoropolymer seed comprises from 3 to 30 wt % hexafluoropropylene.

6. (canceled)

7. The coated separator of claim 1, wherein the fluoropolymer-acrylic resin contains monomers that contain functional groups that can crosslink.

8. (canceled)

9. The coated separator of claim 1, wherein the fluoropolymer-acrylic resin contains monomer units selected from the group consisting of acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether.

10. The coated separator of claim 1, wherein at least one or more of the acrylic monomers is selected from the group consisting of methyl methacrylate, methacrylic acid, methacrylate, 2-hydroxyethyl methacrylate, 4-hydroxybutyl methacrylate, ethyl acrylate, butyl acrylate, propyl acrylate, acrylic acid, diacetone acrylamide, polymethoxydiethylene glycol (meth)acrylate and combinations thereof.

11. (canceled)

12. (canceled)

13. (canceled)

14. The coated separator of claim 1, wherein said adhesive layer further comprises 50 to 99 weight percent of inorganic particles, based on the combined weight of polymer and inorganic particles, wherein said inorganic particles being electrochemically stable inorganic particles.

15. (canceled)

16. The coated separator of claim 1, wherein said adhesive layer further comprises 50 to 99 weight percent of inorganic particles, based on the combined weight of polymer and inorganic particles, wherein said inorganic particles being electrochemically stable inorganic particles, and said inorganic particles are selected from the group consisting of MgO, bohemite (y-AlO(OH)), Al₂O₃, nano-clays, or mixtures thereof.

17. (canceled)

18. (canceled)

19. (canceled)

20. A component of an electrochemical device, wherein said component has directly coated on at least one side thereof a dried crosslinked fluoropolymer-acrylic composition, wherein the fluoropolymer-acrylic composition comprises a fluoropolymer-acrylic resin, the resin comprising from 5 to 50 wt % acrylic monomer units based upon the total weight of the fluoropolymer-acrylic resin, wherein the resin is a composition comprising an acrylic monomer polymerized in the presence of a fluoropolymer seed,
wherein said coated component is a separator or electrode;
wherein said dried, fluoropolymer-acrylic composition has a dry adhesive strength of greater than 10 N/m, preferably greater than 15 N/m, as measured by 180 degree peel strength measurement.

21. A method for forming a coated separator comprising
a) the steps of dip-coating, spray coating, micro-gravure coating or slot coating at least one side of a separator with a crosslinkable fluoropolymer-acrylic composition,
b) drying said coated separator at a temperature of from 25 to 85 C, to form a dried adhesive layer, on the separator,
wherein the composition comprises a fluoropolymer-acrylic resin, the resin having and from 5 to 50 wt % acrylic monomer units based upon the total weight of the fluoropolymer-acrylic resin, wherein the resin is a composition comprising an acrylic monomer polymerized with a fluoropolymer seed.

22. (canceled)

23. The method of claim 21, wherein the fluoropolymer seed comprises a vinylidene fluoride polymer comprising at least 50 weight percent VDF.

24. The method of claim 21, wherein the seed comprises a polyvinylidene fluoride-hexafluoropropylene copolymer, wherein the total weight percent of hexafluoropropylene monomeric units in the fluoropolymer-acrylic resin is from 5 to 20 wt % based on the total weight percent of fluoropolymer-acrylic resin in the adhesive layer.

25. The method of claim 21, wherein the fluoropolymer seed comprises from 3 to 30 wt % hexafluoropropylene.

26. The method of claim 21, wherein the acrylic polymer contains monomers that contain functional groups that can crosslink.

27. (canceled)

28. The method of claim 21, wherein the acrylic polymer contains monomer selected from the group consisting of acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether.

29. The method of claim 21, wherein at least one or more of the acrylic monomers is selected from the group consisting of methyl methacrylate, methacrylic acid, methacrylate, 2-hydroxyethyl methacrylate, 4-hydroxybutyl methacrylate, ethyl acrylate, butyl acrylate, propyl acrylate, acrylic acid, diacetone acrylamide, polymethoxydiethylene glycol (meth)acrylate, and combination thereof.

30. (canceled)

31. The method of claim 21, wherein the fluoropolymer-acrylic resin is self cross linking.

32. The method of claim 21, wherein the fluoropolymer-acrylic composition comprises a cross-linking agent.

33. The method of claim 21, wherein said adhesive layer further comprises 50 to 99 weight percent of inorganic particles, based on the combined weight of polymer and inorganic particles, wherein said inorganic particles being electrochemically stable inorganic particles.

34. The method of claim 21, wherein said fluoropolymer-acrylic resin is dissolved in solvent prior to the coating step.
